(19) United States
(12) Patent Application Publication
(10) Pub. No.: US 2026/0005549 A1
(43) Pub. Date: Jan. 1, 2026

(54) DEVICE ISOLATION WHEN ON WIRELESS POWER SOURCE

(71) Applicant: Midea Group Co., Ltd., Foshan (CN)

(72) Inventor: Michael Grant, Taylorsville, KY (US)

(73) Assignee: Midea Group Co., Ltd., Foshan (CN)

(21) Appl. No.: 18/759,125

(22) Filed: Jun. 28, 2024

(51) Int. Cl. H02J 50/10; H02J 50/40; H02J 50/80; H05B 6/06; H05B 6/44

(52) U.S. Cl. CPC H02J 50/10; H02J 50/40; H02J 50/80; H05B 6/065; H05B 6/44

(57) ABSTRACT

A device isolation system to manage wireless power delivery from multiple pads of a household appliance. The device isolation system includes the household appliance with multiple pads, coils for each pad, a control logic for power distribution, a cloud network for communication of power demand and priorities, and an application on a user device for managing power distribution across the appliances. The coils deliver inductive power for cooking with the household appliance and the control logic distributes power among pads of the household appliance. The cloud network communicates power demands and priorities for the appliances. The application of the user device identifies appliances placed on the pads of the household appliance, sets priorities for the appliances, and modifies an order of execution based on the priorities.

### BACKGROUND

This disclosure relates, in general, to wireless powered appliances, and not by way of limitation, to managing power distribution among multiple appliances for cooking, including other things.

Wireless power transmission is a well-known distribution phenomenon without electrical contact. This technology uses electromagnetic induction to generate electrical current in a conductor by varying its magnetic field. The charger transfers energy through inductive coupling to the coils in the wireless appliance.

The emitter coil, often housed within a charging pad or station, generates a magnetic field when an electric current passes through it. This magnetic field, in turn, induces an electric current in the nearby receiver coil embedded in the portable appliance. This induced current is then converted back into electrical power, effectively charging the battery of the appliance. This process occurs without any direct physical contact between the charging source and the portable appliance, providing a convenient way to power up the portable appliance.

Wireless appliances are intended to have full operation without requiring batteries or cords through wireless power transmission from the power transmitter to the power receiver. The power receiver has no capability to perform any function without an active connection to the power transmitter. Continuous power is not requisite or allowed by some local standby energy limits, but a coupled wired appliance could request it.

### SUMMARY

In one embodiment, the present disclosure provides a device isolation system to manage wireless power delivery from multiple pads of a household appliance. The device isolation system includes the household appliance with multiple pads, coils for each pad, a control logic for power distribution, a cloud network for communication of power demand and priorities, and an application on a user device for managing power distribution across the appliances. The coils deliver inductive power for cooking with the household appliance and the control logic distributes power among pads of the household appliance. The cloud network communicates power demands and priorities for the appliances. The application of the user device identifies appliances placed on the pads of the household appliance, sets priorities for the appliances, and modifies an order of execution based on the priorities.

In an embodiment, a device isolation system to manage wireless power delivery from multiple pads of a household appliance. The device isolation system includes the household appliance with multiple pads, coils for each pad, a control logic for power distribution, a cloud network for communication of power demand and priorities, and an application on a user device for managing power distribution across the appliances. The coils deliver inductive power for cooking with the household appliance and the control logic distributes power among pads of the household appliance. The cloud network communicates power demands and priorities for the appliances. The application of the user device identifies appliances placed on the pads of the household appliance, sets priorities for the appliances, and modifies an order of execution based on the priorities. The household appliance accesses the priorities via the cloud network. The appliances can also access the priorities individually by connecting with the cloud network. The priorities can be directly received from the user device when the cloud network is offline and are also stored at the household appliance when both the user device and the cloud network are offline. A notification is sent on the user device when more power is requested by the appliances than it is available at the household appliance.

In another embodiment, a device isolation method for managing wireless power delivery from multiple pads of a household appliance. In one step, the device isolation method includes cooking at the household appliance with multiple pads, coils for each pad, distributing power with a control logic, communicating of power demand and priorities via a cloud network, and managing power distribution across the appliances via an application on a user device. The coils deliver inductive power for cooking with the household appliance and the control logic distributes power among pads of the household appliance. The cloud network communicates power demands and priorities for the appliances. The application of the user device identifies appliances placed on the pads of the household appliance, sets priorities for the appliances, and modifies an order of execution based on the priorities. The household appliance accesses the priorities via the cloud network. The appliances can also access the priorities individually by connecting with the cloud network. The priorities can be directly received from the user device when the cloud network is offline and are also stored at the household appliance when both the user device and the cloud network are offline. A notification is sent on the user device when more power is requested by the appliances than it is available at the household appliance.

In yet another embodiment, a device isolation appliance to manage wireless power delivery from multiple pads of a household appliance. The device isolation appliance includes the household appliance with multiple pads, coils for each pad, a control logic for power distribution, a cloud network for communication of power demand and priorities, and an application on a user device for managing power distribution across the appliances. The coils deliver inductive power for cooking with the household appliance and the control logic distributes power among pads of the household appliance. The cloud network communicates power demands and priorities for the appliances. The application of the user device identifies appliances placed on the pads of the household appliance, sets priorities for the appliances, and modifies an order of execution based on the priorities. The household appliance accesses the priorities via the cloud network. The appliances can also access the priorities individually by connecting with the cloud network. The priorities can be directly received from the user device when the cloud network is offline and are also stored at the household appliance when both the user device and the cloud network are offline. A notification is sent on the user device when more power is requested by the appliances than it is available at the household appliance.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of a device isolation system for managing wireless power delivery on a household appliance with a cloud network;

FIGS. 2A-2C illustrates a device isolation method for wireless power delivery via pads of the household appliance;

FIG. 3A illustrates an embodiment of configuring priority on the pad via the cloud network;

FIG. 3B illustrates an embodiment of connecting with the cloud individually for the appliances;

FIG. 3C illustrates an embodiment of configuring priorities when there is no network available;

FIG. 3D illustrates an embodiment of configuring priorities when there is no service available;

FIGS. 4A-4B illustrates an application on a user device for managing power delivery and priorities for the appliances;

FIGS. 5A-5C illustrates a flow chart of the device isolation method for managing wireless power delivery on the household appliance with the cloud network; and

FIG. 6 illustrates a flow chart of configuring priorities at the household appliance with a cloud connection.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

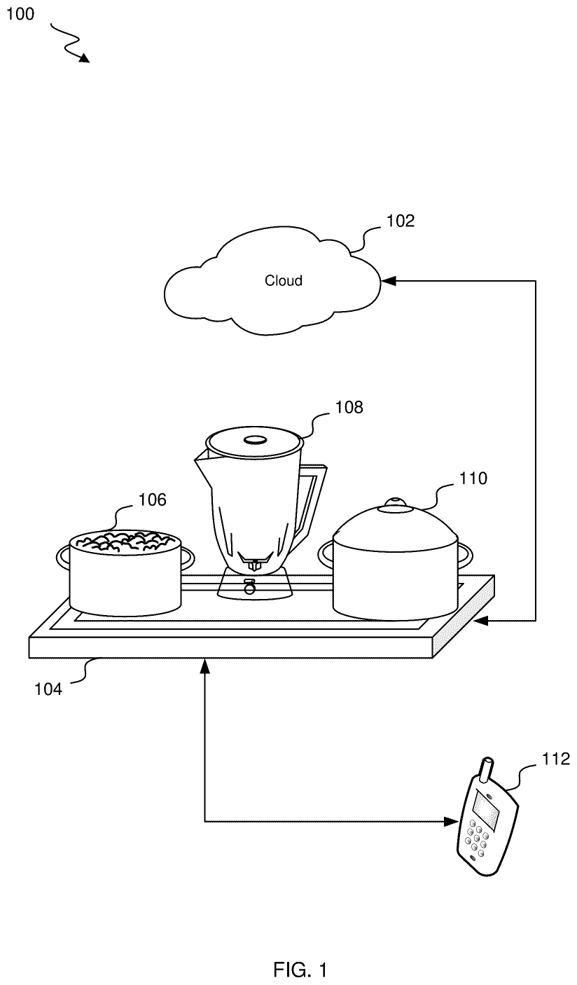

Referring to FIG. 1, a device isolation system 100 for managing wireless power delivery to a household appliance connected with a cloud network is shown. The device isolation system 100 includes a cloud network 102, a household appliance 104, and multiple appliances such as a rice cooker 106, a blender 108, and a pot 110. The device isolation system 100 further includes a user device 112 for communication with the cloud network 102 and the appliances. The device isolation system 100 provides power balancing and priority management to the user by isolating the power delivered to the appliances placed on the same household appliance. When users have wireless power in their kitchens, a problem arises when multiple appliances are placed on a wireless pad of the household appliance 104. With the device isolation system 100, some appliances can take priority while others go to standby mode or low power mode to allow more power to be allocated if there is a situation where there is more demand than supply. Moreover when the cloud network 102 is used to communicate appliance status, battery/capacitor status, and user's priorities, the wireless pad provides a frustration free experience to the user. The cloud network 102 communicates the power demand and the user's priorities to the household appliance 104 and/or to the individual appliances used for cooking.

The household appliance 104 is a wireless power delivery device built into a cooktop, standalone device, counter, or table, eliminating the exigency for power cords in the cooking area. The household appliance 104 contains multiple coils with multiple pads to deliver inductive power. The Ki standard is used to deliver wireless power from household appliance 104 via magnetic induction. However, the household appliance 104 can also use other wireless power delivery standards and is not limited to Ki standard only. There is also a control logic to distribute power among the pads of the household appliance 104. The pads can have different types of induction styles to balance load such as Qi, Qi2, and/or inductive stove pads, etc. Power from the household appliance 104 is provided by inductive power transfer in which a power transmitter draws power from the mains or household power and transfers it by magnetic induction to the appliances. The power is then converted within the appliances into electrical power or heat for cooking. The power receiver in the appliances communicate with the power transmitter in the household appliance 104, to ensure that it receives the precise amount of power exigent to operate within the limits of the appliance and according to the input from the user.

Communication between the power receiver and power transmitter uses near-field communication (NFC) technology and begins as soon as an appliance is placed on the power transmitter of the household appliance 104. In addition to controlling the amount of power transferred, communication enables smart features, such as allowing the power transmitter to distinguish between appliances and other objects. Other forms of communication can also be used, such as, the blender 108 can have a cloud-to-cloud connection via the WiFi between the blender 108 and respective clouds of the wireless power delivery pads. The appliances such as the rice cooker 106, the blender 108, and the pot 110 are exemplary kitchen appliances. Any type of kitchen appliance can be used as a wireless appliance, such as mixers, juicers, kettles, rice cookers, bread makers, coffee makers, wine bottle chillers, slow cookers (crock-pots), griddles, toasters, deep fryers, and more.

The user device 112 hosts an application to manage power distribution across the household appliance 104. The application identifies the appliances (rice cooker 106, blender 108, and pot 110) placed on the pads of the household appliance 104. The user can set priorities for the appliances that include power management, time management etc. and can also modify the order of execution for his cooking based on these priorities. The application on the user device 112 allows appliance-type priority (large appliances/appliances that require power for short periods of time/smart demand appliance (SDA)/ask user etc.), what to do when appliances request large amounts of power (accept/deny/negotiate/use lookup list/follow recipe/ask user etc.), and what appliance to prioritize after short-term power draw event (return to normal/ask user/use lookup list/follow recipe etc.). The smart demand appliance (SDA) refers to appliances that can intelligently manage their power consumption based on priority and other factors. The application on the user device 112 further provides demand response settings, appliance sleep time settings (configures settings when to force the appliance to go to sleep after no activity, follow expected cooking order of priority), and appliance order for power shedding (large appliances/negotiate/use lookup list/follow recipe/SDA/ask user, etc.).

Some embodiments could use a digital assistant (e.g., AI speaker system or AI camera system) to analyze usage of the appliances on the pads of the household appliance 104 passively by the sounds or images gathered. The digital assistant could communicate gathered information and determined inferences to the cloud 102 directly or through a cloud backend for the digital assistant. The digital assistant could command the power level of a pad to not over/under cook the contents instead of a user choosing the power level of their pot/frying pan and the digital assistant was choosing the power level of the user's pot/frying with sound, image, temperature, VOC, and/or other sensors. In other embodiments, the digital assistant and backend could replace the functionality done by the cloud 102 and/or app 112.

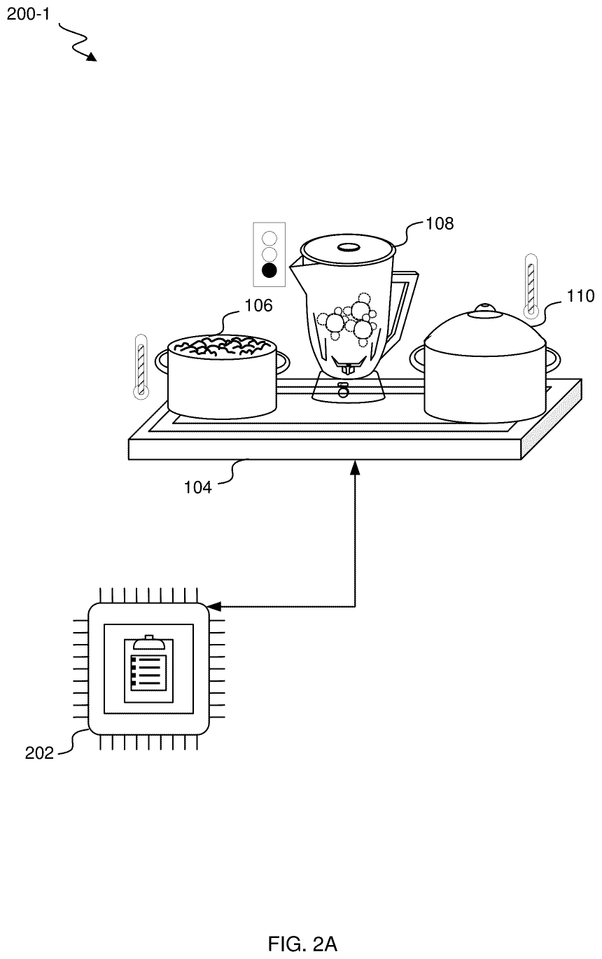

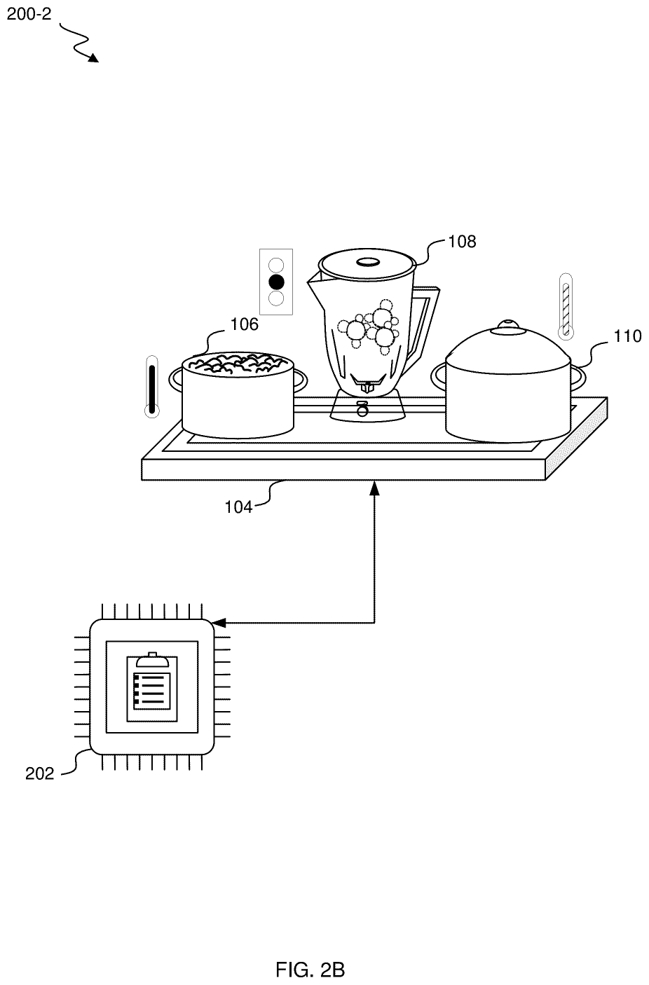

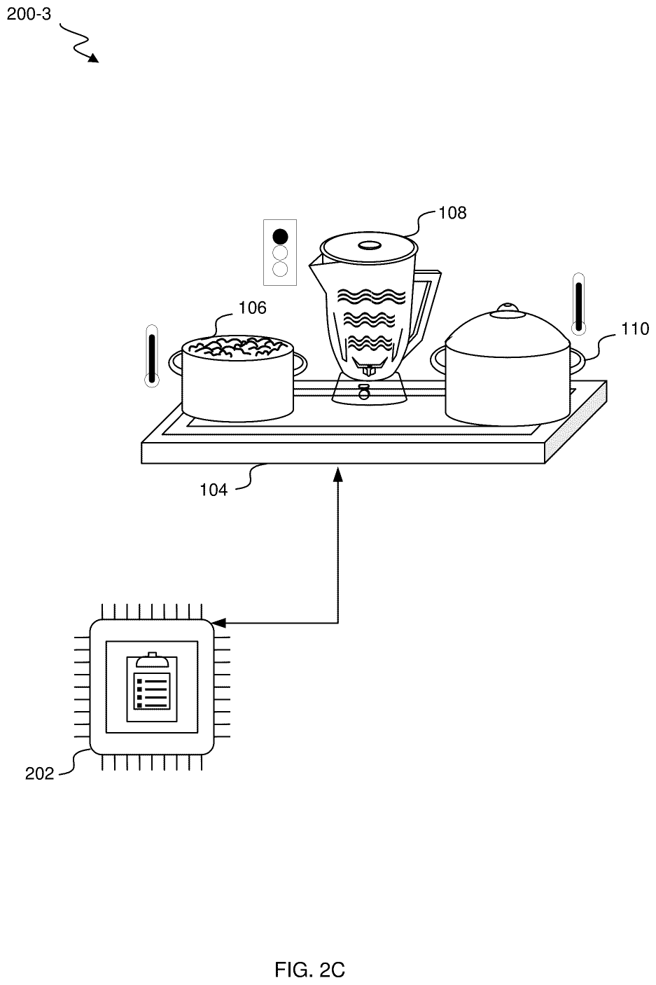

Referring next to FIG. 2A, a device isolation method for managing wireless power delivery at the household appliance 104 as an embodiment 200-1 is shown. The user is trying to cook multiple things when there is not enough Ki power to run multiple appliances at full capacity (from cold to hot), but there is room to place more appliances than there is power potential. There are multiple Ki pads on the surface of the household appliance 104/kitchen countertop. The situation presented is for a non-connected solution vs a connected IoT solution where the user has saved priorities for what to do.

Prior to starting the situation, the user was cooking rice in the rice cooker 106 and maintaining at simmer-low heat, but the rice was HOT. Without custom priorities, the user experience might entail removing and repositioning appliances to obtain priority. In the embodiment 200-1, the user had to take hot rice off to use the blender 108, and by the time the user got to heat the pot 110, the user returned the rice last after placing the big pot first, so the rice cooker 106 did not get the designated priority for power and was cold by the time it was placed back. Once the big pot gets hot, the rice cooker 106 can be warmed up (steps not shown). This means that to give more power to an appliance, the user has to take other appliances off the household appliance 104/cooktop. This is not a viable option when cooking in multiple appliances at a time that has different power demands.

The device isolation appliance provides the household appliance 104 with pads 202 that appreciate the appliances placed on them and contain control logic to distribute power according to the user's priorities. With the device isolation method, the user can run the blender 108 to maximum power while maintaining the rice cooker 106 and the pot 110 at low heat. This means that the blender 108 will get priority in power distribution while food in the rice cooker 106 and the pot 110 will also remain heated.

Referring next to FIG. 2B, another embodiment 200-2 of the device isolation method for wireless power delivery at the household appliance 104 is shown. In the next step, following the execution order according to the priorities, the pads 202 will provide maximum power to the rice cooker 106 and lesser power to the blender 108 and the pot 110. Note that the blender 108 was getting full power previously which is now minimized. In this way, the rice in the rice cooker 106 will get cooked alongside the juice prepared in the blender 108. This is just an exemplary priority list that is executed for explanation. The user can adjust the priorities, power delivery, and time according to his liking. The user can also make the device isolation appliance follow a priority list from a recipe without feeding the information manually into the system.

Referring next to FIG. 2C, another embodiment 200-3 of the device isolation method for wireless power delivery at the household appliance 104 is shown. In the last step, the pads 202 of the household appliance 104 stops power delivery to the blender 108 and gives maximum power to the rice cooker 106 and the pot 110. In this way, the pads 202 of the household appliance 104 provides power to the appliances without keeping any appliance idle. The pads 202 can have a default priority list installed on them. The user can modify this priority list on the household appliance 104 or even the appliances can individually connect with the cloud network 102 to consult the custom priority list.

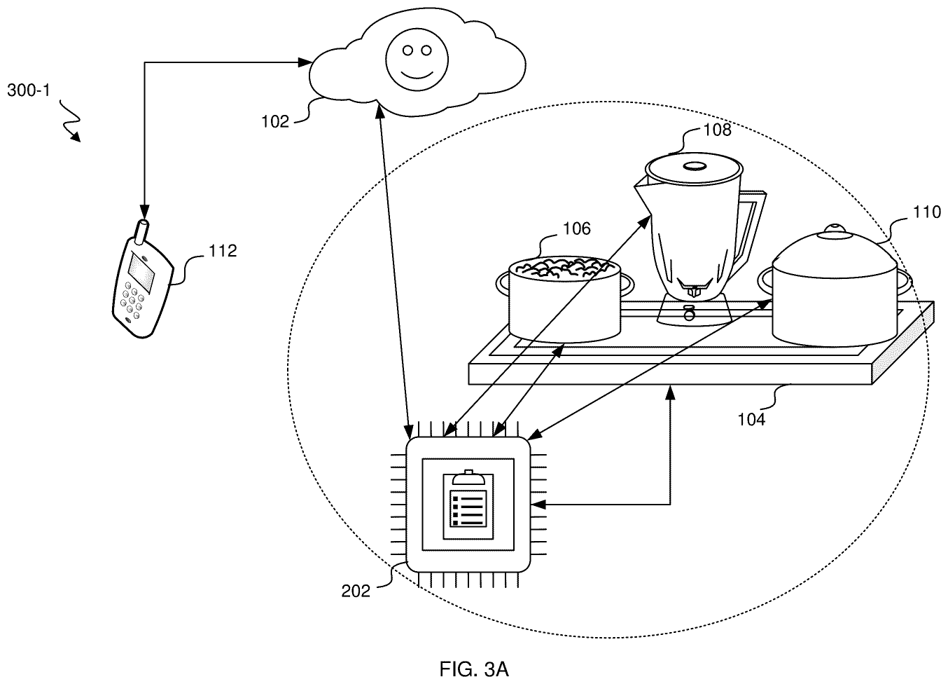

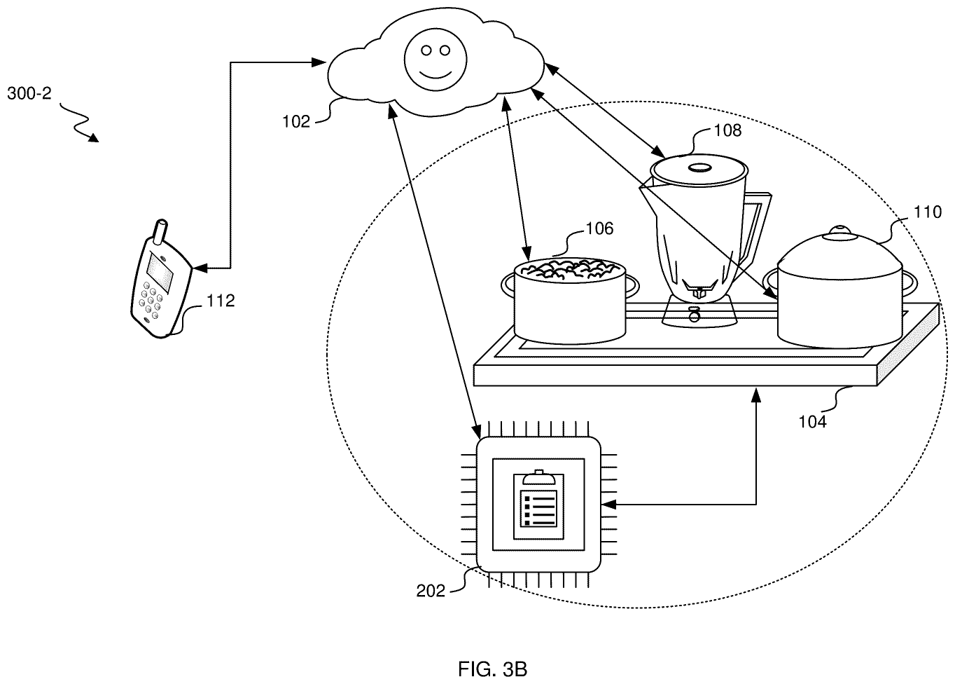

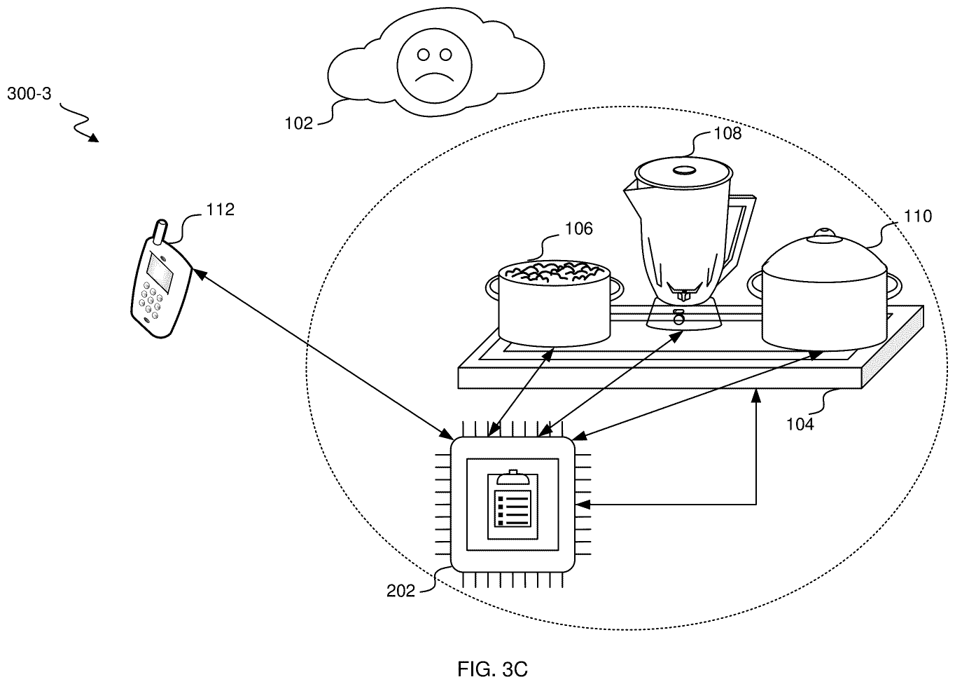

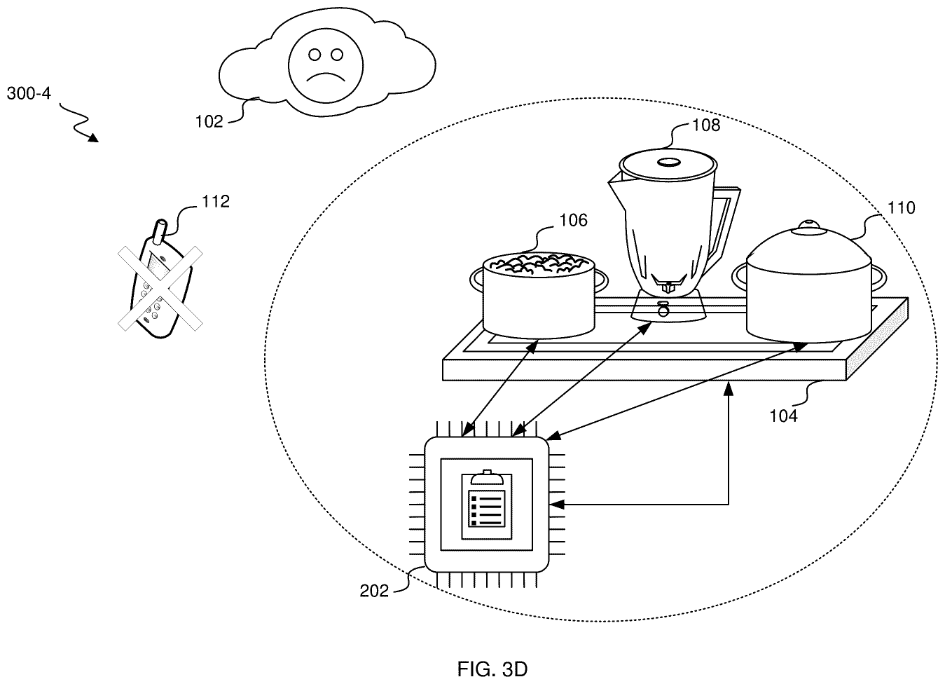

Referring next to FIG. 3A, an embodiment of configuring priority 300-1 on the pad 202 via the cloud network 102 is shown. The priorities are the user's preferences for delivering power to multiple appliances placed on the pad 202. The user configures these priorities from the user device 112. The priorities are stored on the cloud network 102 and at the household appliance 104. So, in any case, the household appliance 104 has multiple options to access the priorities for a particular situation. The appliances (rice cooker 106, blender 108, and pot 110) access these priorities from the pads 202 of the household appliance 104. The device isolation system 100 checks if the cloud is online or not i.e., if the household appliance 104 or the appliances have an active wi-fi connection and can transmit data over the Internet or not. Other means of connecting to the user device 112 can also be employed. For example, the appliance might use Thread™ or Bluetooth™ to connect with and go through the user device 112 to access the web if internet is not available. In one embodiment, the user device 112 is connected to multiple Bluetooth low energy (BLE) devices at once and the household appliance 104 might also be connected to multiple user devices via BLE or through other means (Thread/Cloud) to access the priority list. If the cloud is not online, the household appliance 104 keeps the current default priority list of the appliances for cooking. On the other hand, if the cloud is online, the device isolation system 100 checks if the cloud has a new priority list to replace the previous default list.

The current default list is restored if the cloud does not have a new priority list. On the other hand, if the cloud has a new priority list to replace the previous default list, then the device isolation system 100 checks if the user overwrote the factory default list or not. If the user did not overwrite the factory default list, then the current default list is restored at the household appliance 104. However, if the user overwrote the factory default list, then the current default list is purged. A new priority list is pulled from the cloud and saved as the new system default priority list at the household appliance 104.

Referring next to FIG. 3B, an embodiment 300-2 of connecting with cloud individually to the appliances, is shown. If the appliances (rice cooker 106, blender 108, and pot 110) are not able to access priorities from the pads 202 directly, then the cloud network 102 can control the appliances via the pads 202 . . . . Modern appliances usually have a wi-fi connection and can connect to the cloud. The cloud network 102 gets connected to the appliances on the household appliance 104 via the pads 202 and determines the power/temperature demand by following a recipe or looking at user's priorities. In case of no user preferences, the appliances simply follow the system default priority list, accessible from the cloud network 102.

Referring next to FIG. 3C, an embodiment of configuring priorities when there is no network available 300-3 is shown. When the cloud network 102 is unavailable, the user's preferences or the priority list is directly loaded into the pads 202 of the household appliance 104. The user configures the priorities through the application on the user device 112. The user device 112 connects directly with the household appliance 104. The household appliance 104 has an appreciation of the type of appliance placed on top of it and uses the control logic to distribute power among the pads 202 according to the priority list. This means that the user can still control the order of execution while cooking even when the cloud network 102 is not available i.e., the cloud is offline.

Referring next to FIG. 3D, an embodiment of configuring priorities when there is no service available 300-4 is shown. In the case when no cellular and cloud service is available, the appliances use the priority list that is stored in the household appliance 104. The household appliance 104 has a flash memory that stores the current priority list of the user. If the user updates his preferences, the priority list gets updated once the network becomes available. The device isolation system 100 also checks if the priority list has been updated since the last iteration whenever the user becomes available. If the priority list has been changed since the last iteration, the device isolation system 100 updates the new priority list. The pads 202 of the household appliance 104 has a priority list perpetually stored in it to use when no third-party help is available.

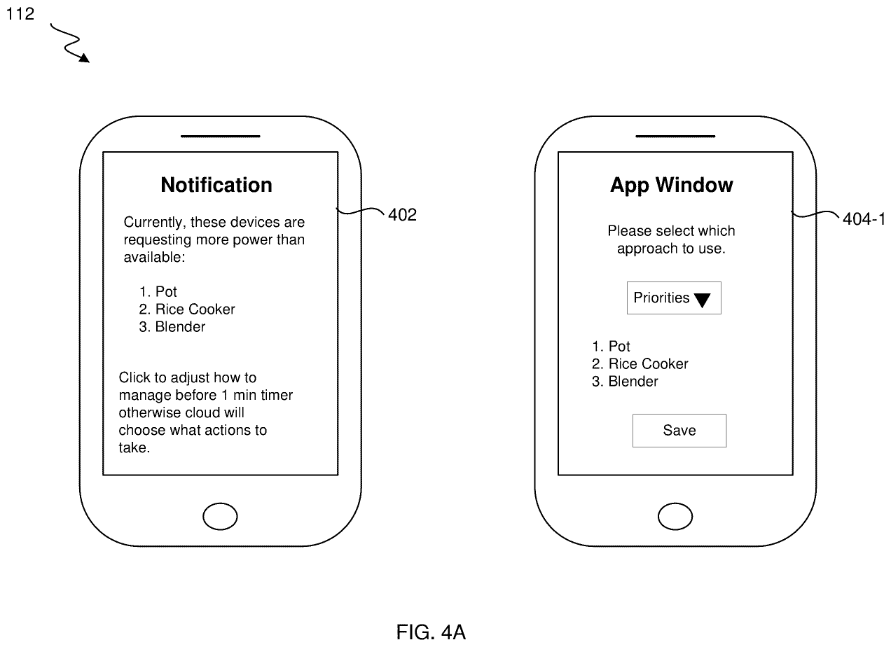

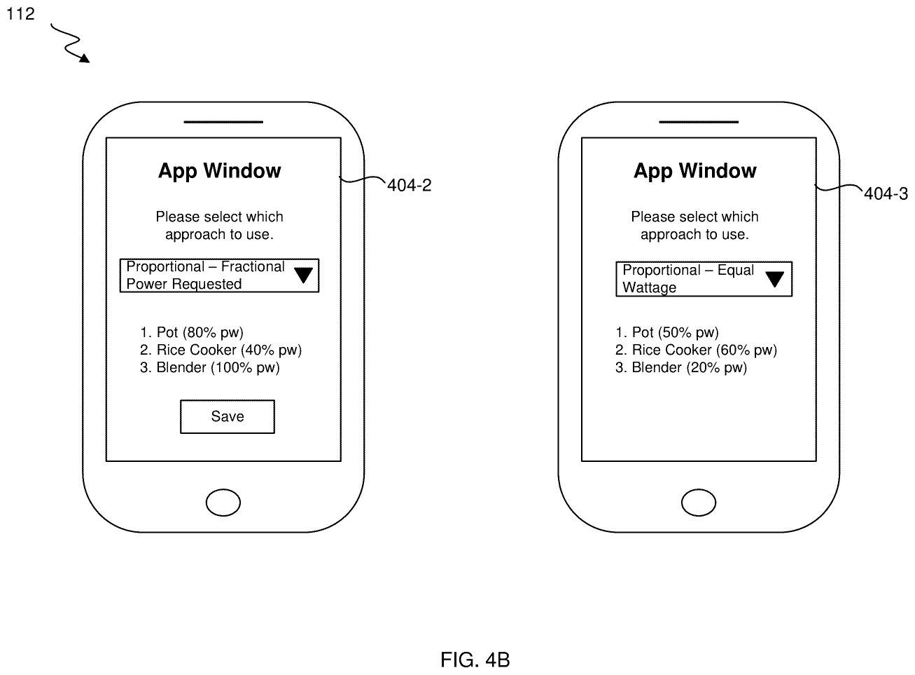

Referring next to FIG. 4A, an application on the user device 112 for managing power delivery and priorities for the appliances is shown. The application identifies the appliances placed on the pads 202 of the household appliance 104. The application further allows setting priorities for the appliances and modifying an order of execution for cooking with the appliances based on the priorities. The application on the user device 112 allows appliance-type priority (large appliances/appliances that entail power for short periods of time/SDA/ask user etc.), what to do when appliances request large amounts of power (accept/deny/negotiate/use lookup list/follow recipe/ask user etc.), and what appliance to prioritize after short-term power draw event (return to normal/ask user/use lookup list/follow recipe, etc.). The application on the user device 112 further provides demand response settings, appliance sleep time settings (configures settings when to force appliance to go to sleep after no activity, follow expected cooking order of priority), and appliance order for power shedding (large appliances/negotiate/use lookup list/follow recipe/SDA/ask user etc.).

The user gets a notification 402 on the user device 112 for requesting power for multiple appliances. The notification 402 is sent when the requested power is more than the available power at the household appliance 104. The notification 402 lists the appliances that entail the power at a time and asks the user how to manage the power distribution before timeout. The exemplary timeout at the notification 402 is 1 min. If the user does not respond to the notification 402 before timeout, the cloud network 102 will automatically choose what actions to take. In one embodiment, a digital assistant (think AI, cloud, Alexa etc.) commands the power level of the pad 202 to not over/under cook the contents instead of a user choosing the power level of their appliances. The digital assistant has feedback such as a camera, a temperature probe etc. to decide the level of power delivery at the household appliance 104.

The application on the user device 112 also presents an app window 404-1 where the user can choose a priority from the saved priorities in the application. The user can also create a new list of priorities to manage power distribution differently from the last iteration.

Referring next to FIG. 4B, an application on the user device 112 for managing power delivery and priorities for the appliances is shown. The app window 404-2 presents different approaches for the user to select from. The user can set priorities with fractional proportional of the requested power at the app window 404-2. The user can also make a priority list according to the wattage requirements of the appliances at the app window 404-3. In this way, the user can define a percentage of the total power that will be provided to individual appliances in a particular case. The user can also load a recipe from the Internet or manually into the application and set the priorities according to the recipe automatically. Furthermore, the application of the user device 112 also shows the safe power ranges for the appliances based on their manufacturing types and capacity.

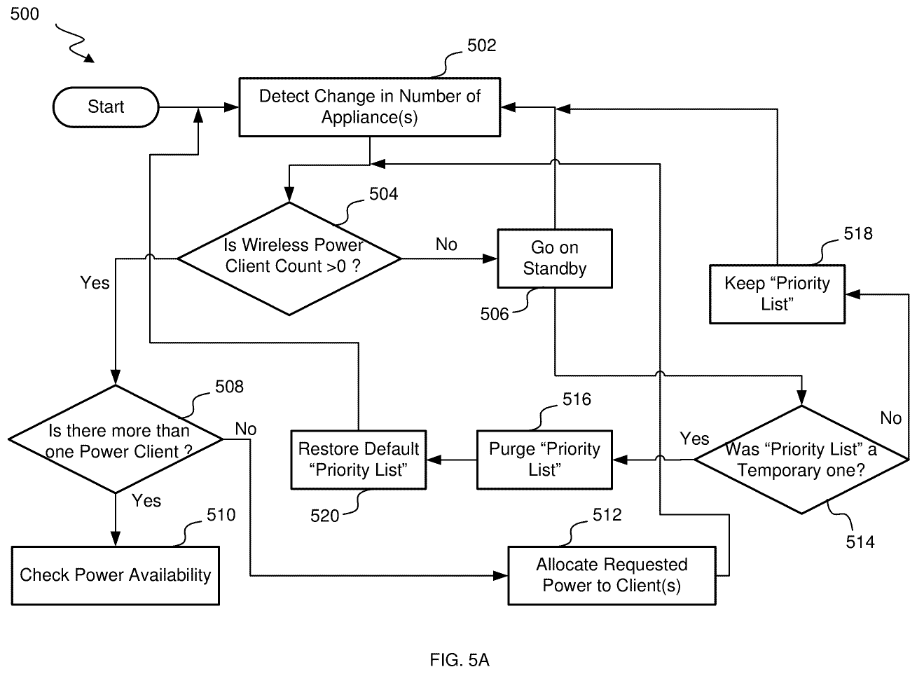

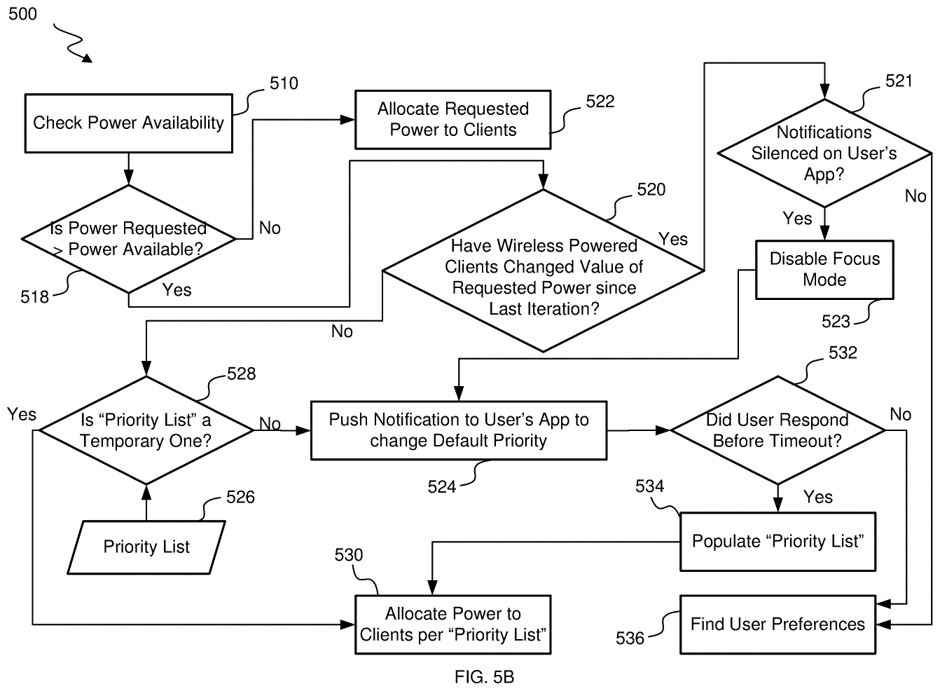

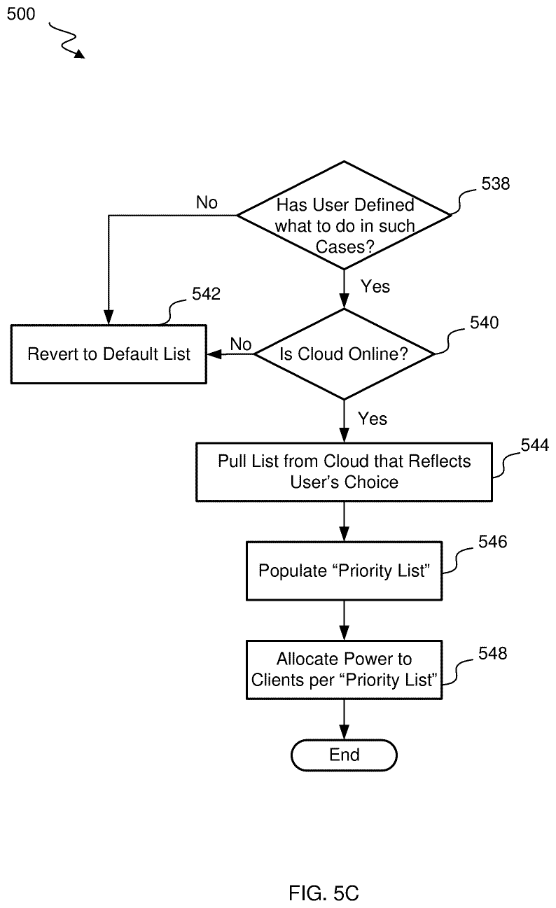

Referring next to FIG. 5A, a flow chart of the device isolation method 500 for managing wireless power delivery on the household appliance 104 with the cloud network 102 is shown. At block 502, the device isolation system 100 detects the number of appliances placed on the household appliance 104/wireless cooktop. The device isolation system 100 detects any change in the number of appliances compared to the previous activity. The household appliance 104 has multiple coils for the multiple pads that deliver inductive power for cooking. The household appliance 104 has an appreciation of the appliance type, which can also be set by the application on the user device 112.

At block 504, the device isolation system 100 determines the wireless power client count. The wireless power client count refers to the number of appliances placed on the household appliance 104 for cooking purposes. If the number of appliances placed on the household appliance 104 is zero, then the device isolation system 100 goes on standby mode at block 506. If the number of appliances is greater than zero, then the household appliance 104 checks if there are more than one power client or appliance at block 508.

If there is more than one power client, the device isolation system 100 checks power availability at block 510. On the other hand, if there is one power client or appliance alone placed on the household appliance 104 at block 508, then the device isolation system 100 allocates the requested power to the appliances or the clients at block 512. After allocating power to the appliances, the device isolation system returns to block 504 and keeps repeating the process.

Furthermore, the device isolation system 100 checks if the priority list is a “temporary one” at block 514. If the priority list is not temporary but permanent, the device isolation system 100 keeps the priority list at block 518. On the other hand, if the priority list was temporary, then the device isolation system 100 purges the priority list at block 516 and restores the default priority list at block 520. After restoring the default priority list of the user, the device isolation system 100 starts over and repeats the process.

Referring next to FIG. 5B, a flow chart of the device isolation method 500 for managing wireless power delivery from the household appliance 104 connected with the cloud network 102 is shown. After checking the power availability at block 510, the device isolation system 100 checks if the requested power is more than the available power or not, at block 518. If the requested power is available, it is allocated to the clients or the appliances at block 522. On the other hand, if more power is requested than is available, the device isolation system 100 checks if the users have changed the value of requested power since the last iteration at block 520. If the user hasn't changed the requested power for the appliances since the last iteration, then the device isolation system 100 checks if the priority list was a temporary one or not at block 528. For this purpose, the device isolation system 100 loads the priority list into the household appliance 104 and checks if the priority list was a temporary one or a non-temporary one, at block 526. On the other hand, if the user has changed the value of requested power for the appliances since the last iteration, then the device isolation system 100 checks if the notifications on the application of the user device 112 have been silenced or not at block 521. The user can do so by enabling a focus mode on the user device 112. If the user has silenced the notifications, then focus mode is disabled at block 523. If the user has not silenced the notifications, then user preferences are configured at block 536.

If the priority list is a temporary one, then power is allocated to the appliances as per the priority list, at block 530. On the other hand, if the priority list is not temporary and the focus mode has been disabled at the user device 112 so that notifications are no longer silenced, the device isolation system 100 pushes a notification to the application on the user device 112 to change the default priority on the household appliance 104 at block 524.

Next at block 532, the device isolation system 100 checks if the user has responded to the notification before the timeout. If the user responds to the notification before timeout, then the device isolation system 100 populates the new priority list of the user, at block 534. On the other hand, if the user did not respond to the notification before the timeout, the device isolation system 100 finds user preferences at block 536. For this purpose, the device isolation system 100 employs user's previous choices or makes an intelligent guess.

Referring next to FIG. 5C, a flow chart of the device isolation method 500 for managing wireless power delivery from the household appliance 104 with the cloud network 102 is shown. At block 538, the device isolation system 100 determines if the user has defined what to do in cases where the notification is left un-responded. If the user has not defined any preferences, then the device isolation system 100 reverts to the default list, at block 542. On the other hand, if the user has instructed some preferences, then the device isolation system 100 checks if the cloud is online or not at block 540.

If the cloud is not online, the device isolation system 100 reverts to the default list at block 542. On the other hand, if the cloud is online then the device isolation system 100 pulls list from the cloud that reflects user's choice at block 544.

At block 546, the device isolation system 100 populates the priority list acquired from the cloud network 102. Finally, at block 548, the household appliance 104 of the device isolation system 100 allocates power to the appliances as per the priority list.

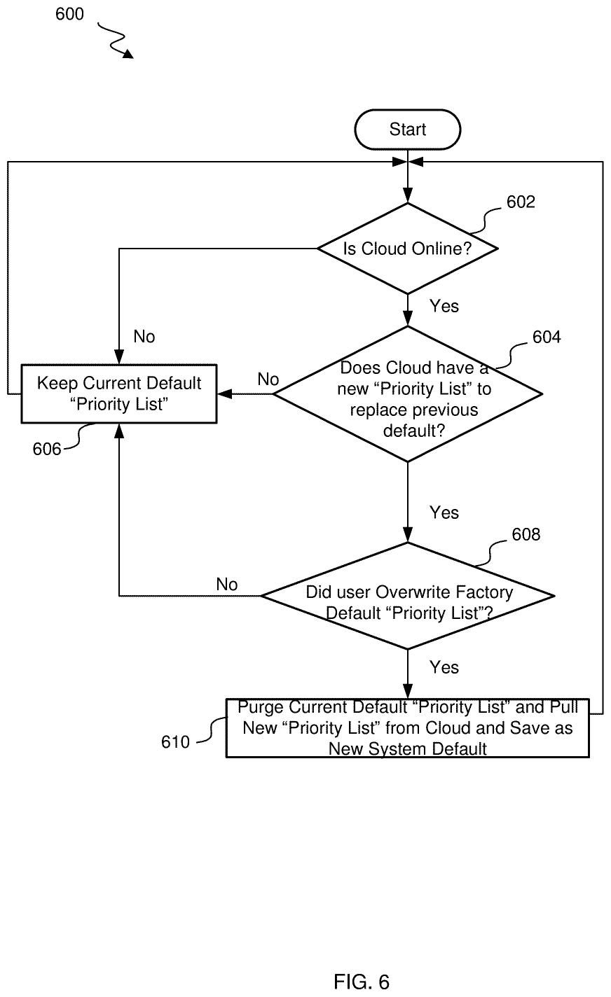

Referring next to FIG. 6, a flow chart of configuring priorities 600 at the household appliance 104 connected with a cloud connection is shown. At block 602, the device isolation system 100 checks if the cloud is online or not. If the cloud is not online, the household appliance 104 keeps the current default priority list at block 606. On the other hand, if the cloud is online, the device isolation system 100 checks if the cloud has a new priority list to replace the previous default list at block 604.

At block 606, the current default list is restored if the cloud does not have a new priority list. On the other hand, if the cloud has a new priority list to replace the previous default list, then the device isolation system 100 checks if the user overwrote the factory default list or not at block 608.

If the user did not overwrite the factory default list, then the current default list is restored at the household appliance 104, at block 606. However, if the user overwrote the factory default list, then the current default list is purged, at block 610. A new priority list is pulled from the cloud and saved as the new system default priority list at the household appliance 104 at block 610.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A device isolation system for managing wireless power delivery, the device isolation system comprises:
a household appliance with a plurality of pads, wherein the household appliance comprises:
a plurality of coils for the plurality of pads, wherein the plurality of coils delivers inductive power for cooking with the household appliance; and
a control logic to distribute inductive power among the plurality of pads;
a cloud network to communicate a power demand and a plurality of priorities; and
an application on a user device to manage power distribution across the plurality of pads of the household appliance, the application is operable to:
identify an appliance of a plurality of appliances placed on the plurality of pads of the household appliance;
set the plurality of priorities for the plurality of appliances; and
modify an order of execution of cooking with the plurality of appliances based on the plurality of priorities.

2. The device isolation system of claim 1, wherein the household appliance accesses the plurality of priorities via the cloud network.

3. The device isolation system of claim 1, wherein the plurality of appliances has a wi-fi connection, and the plurality of appliances access the plurality of priorities individually via the cloud network.

4. The device isolation system of claim 1, wherein the household appliance accesses the plurality of priorities directly from the user device when the cloud network is offline.

5. The device isolation system of claim 1, wherein the plurality of priorities is stored at the household appliance when both the user device and the cloud network are offline.

6. The device isolation system of claim 1, wherein a notification is sent on the user device when more inductive power is requested by the plurality of appliances than it is available.

7. The device isolation system of claim 1, wherein the cloud network chooses a priority of the plurality of priorities when a user does not respond to a notification before a timeout.

8. A device isolation method for managing wireless power delivery from a plurality of pads of a household appliance, the device isolation method comprising:
delivering inductive power by a plurality of coils of the plurality of pads for cooking with the household appliance;
distributing inductive power among the plurality of pads via a control logic;
communicating a power demand and a plurality of priorities via a cloud network; and
managing power distribution across the plurality of pads of the household appliance via an application on a user device, the application further comprises:
identifying an appliance of a plurality of appliances placed on the plurality of pads of the household appliance;
setting the plurality of priorities for the plurality of appliances; and
modifying an order of execution of cooking with the plurality of appliances based on the plurality of priorities.

9. The device isolation method of claim 8, wherein the household appliance accesses the plurality of priorities via the cloud network.

10. The device isolation method of claim 8, wherein the plurality of appliances has a wi-fi connection, and the plurality of appliances access the plurality of priorities individually via the cloud network.

11. The device isolation method of claim 8, wherein the household appliance accesses the plurality of priorities directly from the user device when the cloud network is offline.

12. The device isolation method of claim 8, wherein the plurality of priorities is stored at the household appliance when both the user device and the cloud network are offline.

13. The device isolation method of claim 8, wherein a notification is sent on the user device when more inductive power is requested by the plurality of appliances than it is available.

14. The device isolation method of claim 8, wherein the cloud network chooses a priority of the plurality of priorities when a user does not respond to a notification before a timeout.

15. A device isolation appliance for managing wireless power delivery, the device isolation appliance comprises:
a household appliance with a plurality of pads, wherein the household appliance comprises:
a plurality of coils for the plurality of pads, wherein the plurality of coils delivers inductive power for cooking with the household appliance; and
a control logic to distribute inductive power among the plurality of pads;
a cloud network to communicate a power demand and a plurality of priorities; and
an application on a user device to manage power distribution across the plurality of pads of the household appliance, the application is operable to:
identify an appliance of a plurality of appliances placed on the plurality of pads of the household appliance;
set the plurality of priorities for the plurality of appliances; and
modify an order of execution of cooking with the plurality of appliances based on the plurality of priorities.

16. The device isolation appliance of claim 15, wherein the household appliance accesses the plurality of priorities via the cloud network.

17. The device isolation appliance of claim 15, wherein the plurality of appliances has a wi-fi connection, and the plurality of appliances access the plurality of priorities individually via the cloud network.

18. The device isolation appliance of claim 15, wherein the household appliance accesses the plurality of priorities directly from the user device when the cloud network is offline.

19. The device isolation appliance of claim 15, wherein the plurality of priorities is stored at the household appliance when both the user device and the cloud network are offline.

20. The device isolation appliance of claim 15, wherein a notification is sent on the user device when more inductive power is requested by the plurality of appliances than it is available.
